(19) United States
(12) Patent Application Publication
(10) Pub. No.: US 2004/0228050 A1
(43) Pub. Date: Nov. 18, 2004

(54) Use of unidirectional FET switches for motor electrical disengagement

(75) Inventors: Darrel A. Recker, Ypsilanti, MI (US); Ivana Milosavljevic, Ann Arbor, MI (US)

Correspondence Address: Eric J. Sosenko, Esq., BRINKS HOFER GILSON & LIONE, P.O. Box 10395, Chicago, IL, 60610, US

(73) Assignee: Visteon Global Technologies, Inc.

(21) Appl. No.: 10/436,665

(22) Filed: May 13, 2003

(51) Int. Cl. H02H 7/08

(52) U.S. Cl. 361/23

(57) ABSTRACT

The present invention provides a system for disengaging a motor and preventing dynamic braking current loops. The system includes a power circuit, a gate driver circuit, and unidirectional switches attached to each motor winding. Unidirectional switches such as field effect transistors (FETs) can provide current blocking in only one direction when not conducting. Unidirectional blocking according to the present invention is sufficient for preventing the undesirable dynamic braking current loops. The approach of this invention requires N unidirectional switches, where N is the number of motor windings. Thus, on a 3 phase motor, three unidirectional switches are used, each being in series with one on the motor windings.

### BACKGROUND

1. Field of the Invention

The present invention generally relates to brushless DC motors. More specifically, the invention relates to a system and a method for electrically disengaging a brushless DC motor using a unidirectional switches to prevent a dynamic braking current loop.

2. Description of Related Art

In Electric Power Assist Steering (EPAS) applications, it is undesirable to electrically disengage the motor so that under certain fault conditions a dynamic braking current loop is generated thereby locking the steering wheel. In most motor control applications, including EPAS, the power circuit for energizing the motor is in communication with all of the motor terminals. To aid in disengaging the motor, some of the motor terminals are selectively connected to the power circuit using mechanical relays.

Typically, a mechanical relay is placed in connection with all but one of the motor terminals. Due to the bidirectional current blocking of the mechanical relay, the system is protected from dynamic braking current loops caused by a short in the power circuit. However, the cost, size, power consumption, and low heat dissipation properties of mechanical relays can lead to higher failure rates making these devices undesirable.

Solid state relays can be used to replace mechanical relays. In the solid-state configuration, two unidirectional switches having opposite polarity are used in series to achieve the bidirectional current blocking characteristics of a mechanical relay. The solid-state configuration requires 2*(N−1) unidirectional switches, where N is the number of motor windings. This, however, requires a large number of components in the circuit, increasing complexity and cost.

In view of the above, it is apparent that there exists a need for a system and a method for electrically disengaging a brushless DC motor using a less complex circuit. Preferably, the motor is disengaged using a circuit containing fewer components thereby reducing space, cost, and power consumption.

### SUMMARY

In satisfying the above need, as well as overcoming the enumerated drawbacks and other limitations of the related art, the present invention provides a simplified circuit for disengaging a brushless DC motor using unidirectional switches to prevent a dynamic braking current loop. Specifically, the invention provides a power circuit, a gate driver circuit, and unidirectional switches attached to each motor winding to prevent dynamic braking current loops. Unidirectional switches such as field effect transistors (FETs) can provide current blocking in only one direction when not conducting. Unidirectional blocking, according to the present invention, is sufficient for preventing the undesirable dynamic braking current loops.

The current flowing from of one of the motor windings must return through another motor winding to create a braking current loop. Thus, if current is prevented from entering the power circuit through the unidirectional switches on each winding, it necessarily prevents any current loop from existing through the power circuit. This approach requires N unidirectional switches where N is the number of motor windings. Thus, on a 3 phase motor, three unidirectional switches may be used instead of the four unidirectional switches required to replicate a mechanical relay according to the known technologies.

The same principle may be applied when placing these switches inside the motor, particularly where the motor is Y-wound having a center connection point. The unidirectional switches can be connected between the winding and the center connection point to prevent dynamic current braking loops. Further, this configuration prevents current braking loops from being created as a result of an electrical short between the windings.

The advantages of using unidirectional switches according to the present invention include higher reliability, smaller size, ease of assembly, lower power consumption, and potentially less cost.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a diagrammatic view of a prior art system using mechanical relays to disengage the motor;

FIG. 2 is a diagrammatic view of a prior art system using a three phase bridge to disengage the motor;

FIG. 3 is a diagrammatic view of a system using unidirectional switches to disengage the motor in accordance with the present invention; and

FIG. 4 is a diagrammatic view of an alternate system embodying the principles of the present invention and using unidirectional switches located inside the motor.

### DETAILED DESCRIPTION

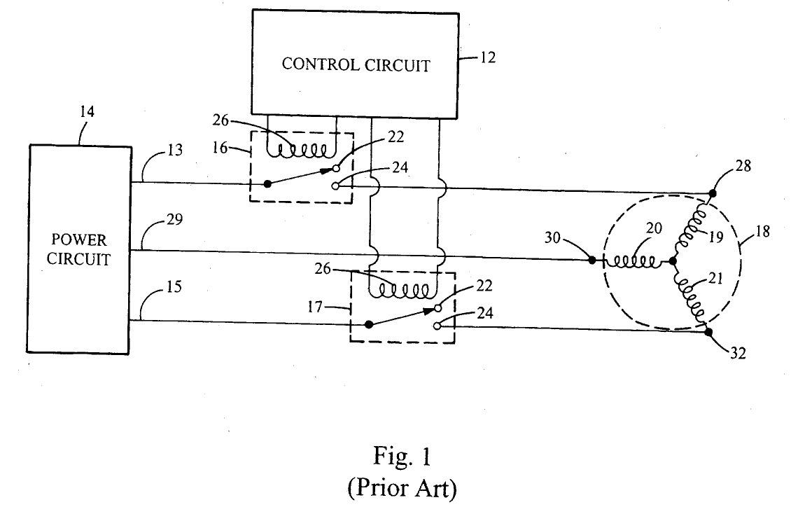

Now referring to FIG. 1, the prior art shows a system for disengaging an electric motor 18 using a control circuit 12, a power circuit 14, and two mechanical relays 16, 17. The power circuit 14 is selectively connected to the motor terminals 28, 32 by the mechanical relays 16, 17 across lines 13 and 15. The power circuit 14 is directly connected to a third motor terminal 30 by line 29. Based on a signal from the control circuit 12, the mechanical relays 16, 17 will connect the power circuit 14 to the motor terminals 28, 32.

The mechanical relays 16, 17 each contain a coil 26, a normally open contact 24, and side contact 22. The control circuit 12 engages the motor 18 by energizing the coils 26 of the relays 16, 17 thereby connecting the power circuit 14 to the normally open contact 24. When connected as such, the normally open contact 24 of relays 16, 17 provides power for windings 19, 20 through motor terminals 28, 32.

The control circuit 12 disengages the motor 18 by de-energizing the coils 26 of the mechanical relays 16, 17 causing the power circuit 14 to be connected to the side contact 22. When the power circuit 14 is connected to the side contact 22 of the relays 16 and 17, no current can travel between the power circuit 14 and the windings 19, 21 to form a current braking loop through the power circuit 14. Even though motor terminal 30 and winding 20 are still connected to the power circuit 14 along line 29, the braking current loop cannot be created due to the open condition of the other motor terminals 28, 32 connected to the windings 19, 21. With no return path to complete a current braking loop through winding 19 or winding 21, the system will disengage the motor without creating a braking current loop.

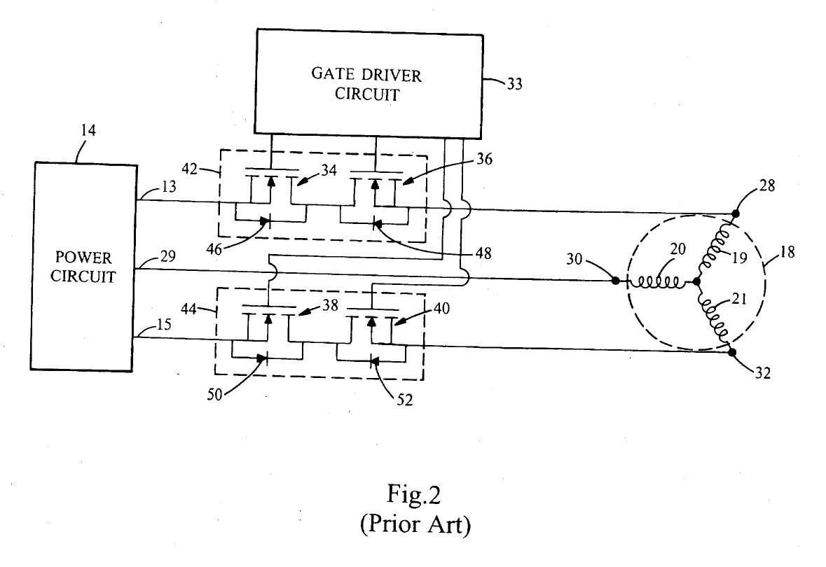

Referring now to FIG. 2, the prior art also shows replacing the mechanical relays 16, 17 of FIG. 1 with solid-state relays 42, 44. In this configuration, a solid-state relay 42 is connected between the power circuit 14 and motor terminal 28. Likewise, a second solid-state relay 44 is connected between the power circuit 14 and motor terminal 32. A gate driver circuit 33 energizes the motor 18 by sending a signal to the solid-state relays 42, 44 which causes the solid state relays to conduct across lines 13 and 15 between the power circuit 14 and motor terminals 28 and 32, respectively.

The solid-state relay 42, includes a pair of field effect transistors 34, 36 connected in opposite polarity. Similarly, the solid-state relay 44 also includes a pair of field effect transistors 38, 40 connected in opposite polarity. When field effect transistor 34 is not conducting, the diode 46 of field effect transistor 34 blocks current from traveling through winding 19 to the power circuit 14. Conversely, when FET 36 is not conducting, diode 48 prevents any current from flowing from the power circuit 14 to winding 19. The cooperation of diode 46 and diode 48 creates a bidirectional blockage of current flow when FETs 34 and 36 are not conducting. Likewise, the diode 50 of field effect transistors 38 prevents any current from flowing from winding 21 to the power circuit 14 when FETs 38 and 40 are not conducting, while diode 52 of field effect transistor 40 prevents any current from flowing from the power circuit 14 to the winding 21. Therefore, the field effect transistor pairs 34, 36 and 38, 40 act as bidirectional switches providing the same effect as mechanical relays for preventing dynamic braking current loops.

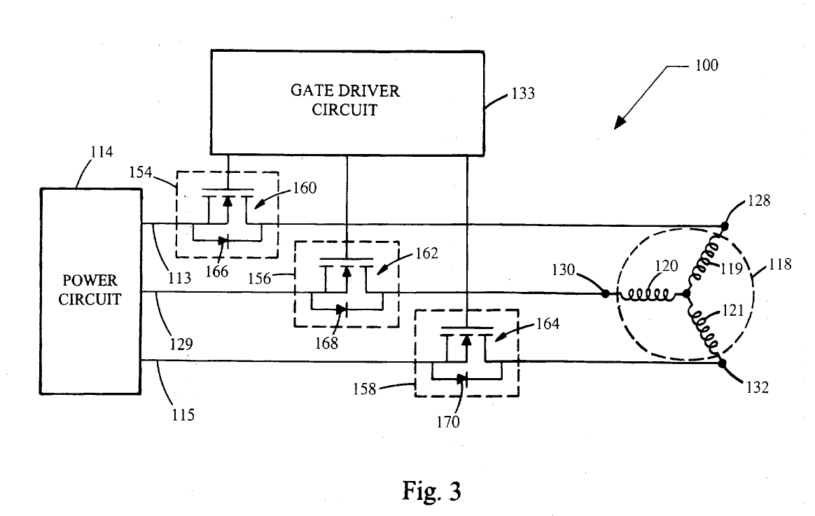

Now referring to FIG. 3, a first embodiment of the present invention is illustrated therein. A system 100 according to the present invention provides a. power circuit 114, a gate driver circuit 133, and unidirectional switches 154, 156, 158 respectively in series connection with each of the motor windings 119, 120, 121. The gate driver circuit 133 energizes the motor 118 by providing a signal to the unidirectional switches 154, 156, 158 causing them to conduct between the power circuit 114 and the motor terminals 128, 130, 132. This results in the powering of the windings 119, 120, 121. To disengage the motor 118 the gate driver circuit 133 provides a signal to the unidirectional- switches 154, 156, 158 causing the unidirectional switches 154, 156, 158 to stop conducting. The unidirectional switches 154, 156, 158 are all oriented in the same polarity relative to the motor windings 119, 120, 121.

As one skilled in the art would appreciate, variations of the power circuit 114 and the gate driver circuit 133 are generally available for EPAS systems. The power circuit 114 can be accomplished, for example, using a well known three-phase bridge or power inverter. Similarly, the gate driver circuit 133 can be accomplished using commercially available integrated circuits.

In the configuration of this invention, the unidirectional switches 154, 156, 158 are sufficient for preventing a dynamic braking current loop. In order to form a dynamic braking current loop, the current flowing from one of the motor windings must return through another motor winding. Thus, if current is prevented from entering the power circuit 114 through the unidirectional switches 154, 156, 158 on each winding 119,120,121, it necessarily prevents any current loop from existing through the power circuit 114. This approach requires N unidirectional switches where N is the number of motor windings or legs. Thus, on a 3 phase motor, only three unidirectional switches (instead of the four unidirectional switches required to replicate a mechanical relay) need be used.

The unidirectional switches 154, 156, 158 are illustrated as including field effect transistors 160, 162, 164. When the field effect transistors are not conducting, diode 166 of field effect transistor 160 prevents any current from flowing from winding 119 to the power circuit 114 along line 113. Similarly, diode 168 of field effect transistor 162 prevents any current from flowing from winding 120 to the power circuit 114, while diode 170 of field effect transistor 164 prevents any current from flowing from winding 121 to the power circuit 114 along line 115. Since no current is allowed to flow from any of the windings 119, 120, 121 to the power circuit 114, a dynamic braking current loop cannot be formed through the power circuit 114.

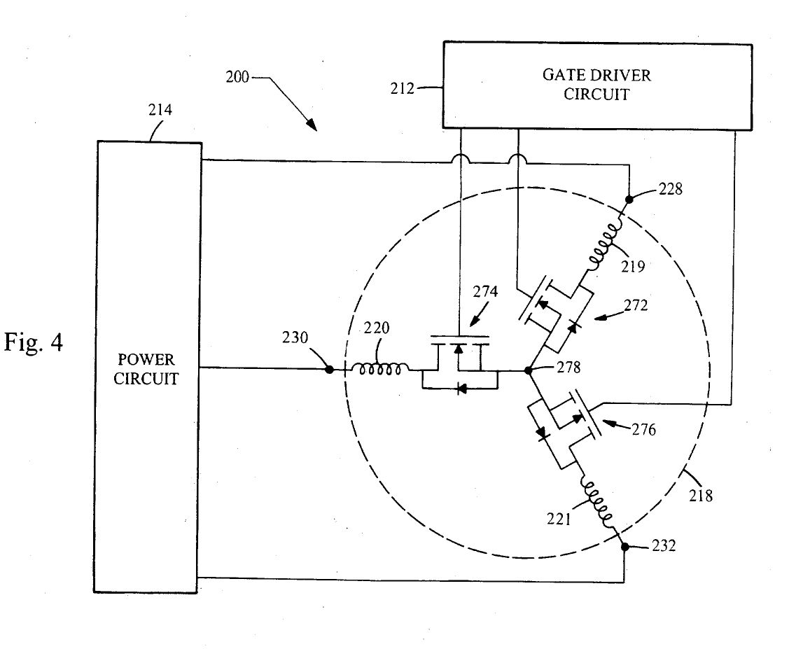

An additional embodiment of a system 200 according to the present invention is illustrated in FIG. 4. In this system 200, unidirectional switches 272, 274, 276 may be connected between the windings 219, 220, 221 and a center terminal 278 of a three phase Y wound motor 218. The unidirectional switches 272, 274, 276 all have the same polarity relative to the windings 219, 220, 221. In this configuration, the unidirectional switches 272, 274, 276 prevent a dynamic braking current loop by blocking any current flowing from the windings 219, 220, 221 to the center contact 278. Connecting the field effect transistor 274, 272, 276 between the windings 219, 220, 221 also has the benefit of preventing a braking current loop from being formed when an electrical short exists between two of the windings 219, 220, 221.

The above embodiments of the present invention may take additional forms, for example, the field effect transistors may be replaced with other unidirectional switches. Similarly, the polarity of all the unidirectional switches can be reversed to prevent any current from flowing in a direction opposite the direction described above.

As a person skilled in the art will readily appreciate, the above description is -meant as an illustration of implementation of the principles this invention. This description is not intended to limit the scope or application of this invention in that the invention is susceptible to modification, variation and change, without departing from -spirit of this invention, as defined in the following claims.

We claim:

1. A system for disengaging a motor, the system comprising:
a motor having a plurality of motor windings;
a plurality of unidirectional switches, the plurality of unidirectional switches being equal in number to the plurality of windings, each winding of the plurality of the windings being in electrical series connection with one of the plurality of unidirectional switches;
a gate driver circuit in communication with each of the unidirectional switches; and
a power circuit in communication with each of the unidirectional switches.

2. The system according to claim 1, wherein each of the unidirectional switches is oriented to prevent current from flowing out of each of the motor windings.

3. The system according to claim 1, wherein each of the unidirectional switches is oriented to prevent current from flowing into each of the motor windings.

4. The system according to claim 1, wherein each unidirectional switch includes a field effect transistor.

5. The system according to claim 4, wherein the field effect transistor of each of the plurality of-the unidirectional switches includes a gate, a source, and drain, wherein the gate is in communication-with the gate driver circuit, the source is in communication with the power circuit, and the drain is in communication with one of the windings of the plurality of windings.

6. The system according to claim 4, wherein the field effect transistor of each of the plurality of the unidirectional switches includes a gate, a source, and drain, wherein the gate is in communication with the gate driver circuit, the source is in communication with one of the windings of the plurality of windings, and the drain is in communication with the power circuit.

7. The system according to claim 1, the motor having a center terminal, wherein each of the unidirectional switches is connected between a winding of the plurality of windings and the center terminal.

8. The system according to claim 7, wherein each unidirectional switch includes a field effect transistor.

9. The system according to claim 8, wherein the field effect transistor of each of the plurality of the unidirectional switches includes a gate, a source, and drain, wherein the gate is in communication with the gate driver circuit, the source is in communication with the center terminal, and the drain is in communication with a winding of the plurality of windings.

10. The system according to claim 8, wherein the field effect transistor of each of the plurality of the unidirectional switches includes a gate, a source, and drain, wherein the gate is in communication with the gate driver circuit, the source is in communication with a winding of the plurality of windings, and the drain is in communication with the center terminal.

11. A system for disengaging a motor, the system comprising:
a motor having a plurality of motor windings;
a plurality of field effect transistors, the plurality of transistors being equal in number to the plurality of windings and cooperating therewith to form a plurality of transistor-winding pairs, each transistor-winding pair including one of the plurality of transistors and one of the plurality of windings being in electrical series connection with each other;
a gate driver circuit in communication with each of the transistor-winding pairs; and
a power circuit in communication with each the transistor-winding pairs.

12. The system according to claim 11, wherein each of the transistors is oriented to prevent current from flowing out of the winding of the transistor-winding pair.

13. The system according to claim 11, wherein each of the transistors is oriented to prevent current from flowing into the winding of the transistor-winding pair.

14. The system according to claim 11, wherein the transistor of each transistor-winding pair is connected between the winding of that transistor-winding pair and the power circuit.

15. The system according to claim 11, wherein the winding of each transistor-winding pair-is connected between the transistor of that transistor-winding pair and the power circuit.

16. The system according to claim 11, the motor having a center terminal, wherein the transistor of each transistor-winding pair is connected between the winding of that transistor-winding pair and the center terminal.

17. The system according to claim 16, wherein each of the transistors includes a gate, a source, and drain, where the gate is in communication with the gate driver circuit, the source is in communication with the center terminal, and the drain is in communication with the winding of the transistor-winding pair.

18. The system according to claim 16, wherein each of the transistors includes a gate, a source, and drain, where the gate is in communication with the gate driver circuit, the source is in communication with the winding of the transistor-winding pair, and the drain is in communication with the center terminal.

19. The system according to claim 11, wherein each transistor of all the transistor-winding pairs is oriented to block the current in a common direction relative to the winding of that transistor-winding pair.

20. The system according to claim 11, wherein each of the transistors includes a gate, a source, and drain, where the gate is in communication with the gate driver circuit, the source is in communication with the power circuit, and the drain is -in communication with the winding of the transistor-winding pair.

21. The system according to claim 11, wherein each of the transistors includes a gate, a source, and drain, where the gate is in communication with the gate driver circuit, the source is in communication with the winding of the transistor-winding pair, and the drain is in communication with the power circuit.
